(19) United States
(12) Patent Application Publication
(10) Pub. No.: US 2017/0137181 A1
(43) Pub. Date: May 18, 2017

(54) FOLDABLE STATUE BAG

(71) Applicant: Fun Chain Co., Ltd., New Taipei City (TW)

(72) Inventors: Min Chun Liao, New Taipei City (TW); Ching Wen Hsiao, New Taipei City (TW); Hsin Yi Lu, New Taipei City (TW)

(73) Assignee: Fun Chain Co., Ltd., New Taipei City (TW)

(21) Appl. No.: 15/352,581

(22) Filed: Nov. 16, 2016

(30) Foreign Application Priority Data
Nov. 18, 2015 (TW) 104218502

(51) Int. Cl. B65D 33/00; F21V 33/00; B65D 33/10

(52) U.S. Cl. CPC B65D 33/004; B65D 33/105; F21V 33/0004; F21Y 2115/10

(57) ABSTRACT

A foldable statue bag is disclosed. The foldable statue bag comprises a foldable bag body with an opening on a top end, and a statue integrated with the foldable bag body. The foldable bag body has two adjacent surfaces connect to a first fold line at opposite sides to form a recess or a protrusion, and the statue has a second fold line for folding so that the statue is received in the recess or protrude from the protrusion when the foldable bag body is folded, and the statue is expanded to form a three dimensional decoration when the foldable bag body is unfolded.

### CROSS REFERENCE

This application claims the benefit and priority of Taiwan patent application 104218502, filed Nov. 18, 2015, and the entire disclosures of each of the above applications are incorporated herein by reference.

### BACKGROUND

Field

This invention is related to a bag. In particular, this invention is related to a bag having a 3-dimensional statue when unfolding, and further having an animation statue.

Description of Related Art

In general, a pattern on the surface of convention bag is plane, some bag has three dimensional likeness configuration, such as the folded and unfolded bags shown in FIG. 1A and FIG. 1B, respectively. The pattern disposed on the bag in FIG. 1A and FIG. 1B is three dimensional likeness, but cannot be folded or unfolded when the bag body is folded or unfolded, so that the pattern is plane pattern and cannot create any special visual effect or animation effect.

It is noted that the plane pattern cannot be well integrated into the bag body to form one statue or one design. Here the inventor propose that the integral of the statue and the bag body can form a 3D sculpture to show a story, an animal or a cartoon. Further the integral of the statue and the bag body can have the dynamical effect, i.e. the statue can flutter, wave or flicker.

### SUMMARY

According to one aspect of this invention, a foldable statue bag is disclosed. The foldable statue bag comprises a foldable bag body with an opening on a top end, and a statue integrated with the foldable bag body. The foldable bag body is divided by a plurality of first fold lines in to several surfaces (regions), and a recess or a protrusion is formed between two adjacent surfaces by each first fold line. The statue has at least one second fold line for folding so that the statue is received in the recess or folded upon the protrusion when the foldable bag body is folded, or expanded to form a three dimensional decoration when the foldable bag body is unfolded.

In some embodiments, the handles can be disposed near the opening and handle recesses are formed at the connection of the handles and the foldable statue bag. A statue can be disposed at the handle recess. The statue is received in the handle recess when the handle is pulled down and expanded to a 3D dimensional statue when the handle is pulled up.

In some embodiments, the sub-fold lines are disposed on the first fold lines of the foldable bag body or the second fold line of the statue. The sub-fold lines make the statue flutter or flicker dynamically. Especially a pattern can be formed on the foldable bag body and extended to the statue and the sub-fold lines can make the bag form an animation statue.

### DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIGS. 1A and 1B are schematic diagrams showing a conventional bag as folding and unfolding states. It is obvious that the 3-D dimensional likeness figuration cannot be received or and varies dynamically.

FIG. 2A is a schematic diagram showing the folded state of a foldable statue bag according to an embodiment of this invention. The folded statue bag looks like a general bag with some drawing on the bag body.

FIG. 2B a schematic diagram showing the unfolded state of the foldable statue bag in FIG. 2A according to one embodiment of this invention. The integral of the bag body and the statue forms a cartoon dog in this case.

FIG. 3 is a schematic diagram of a foldable statue bag according to one embodiment of this invention. The statue is disposed at the interface of the handle and the bag body. The statue expands if the handle is pulled up and received in the recess when the handle is pulled down.

FIG. 4 is a schematic diagram of a triangle base T according to one embodiment of this invention. It shows the basic skill to put a statue on the recess, which is formed by folding the bag body along a first fold line. The statue has a second fold line corresponding to the first fold line.

FIG. 5 is a schematic diagram of a foldable statue bag according to another one embodiment of this invention. The pattern is disposed and extended from the bag body to the statue. The sub-fold lines on the statue to make the integral of the bag body and the statue vary dynamically. For example, the wing flutters when a user carry the bag to walk.

FIG. 6 is a schematic diagram of a foldable bag body according to one embodiment of this invention. It is noted that the first fold lines are on the front side of the bag body and the statue can be disposed on the front surface of the bag.

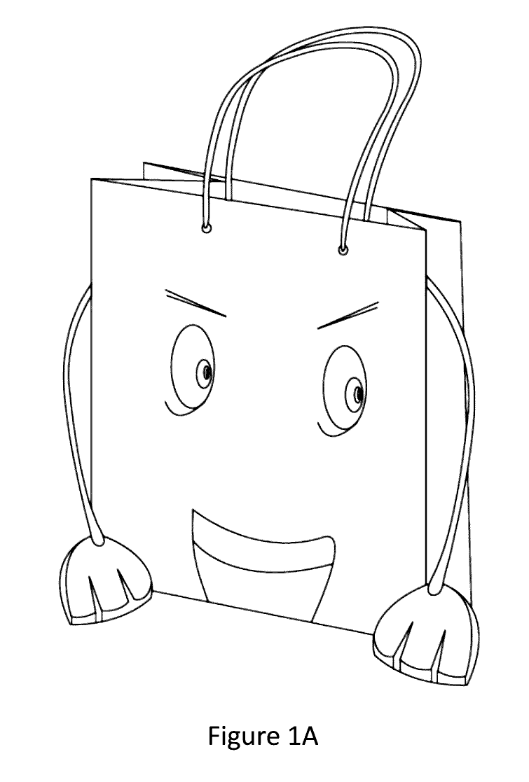

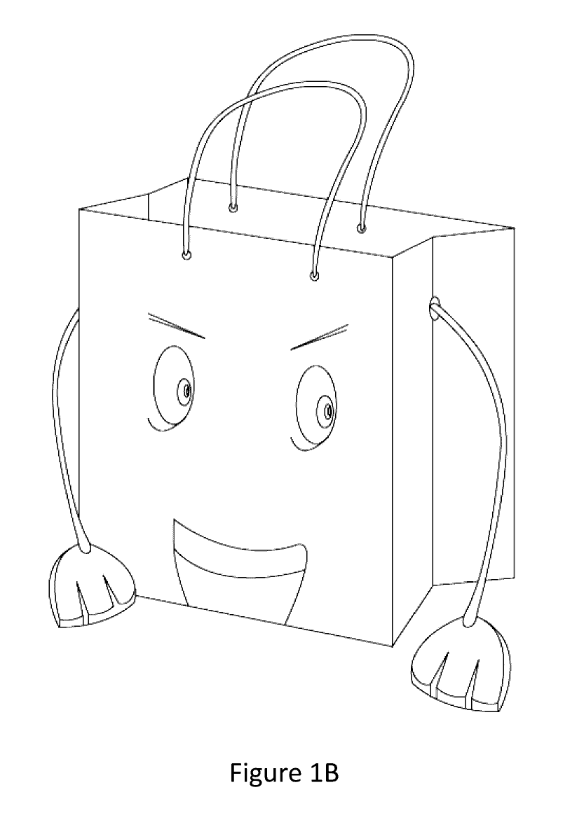

### DETAILED DESCRIPTION

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable.

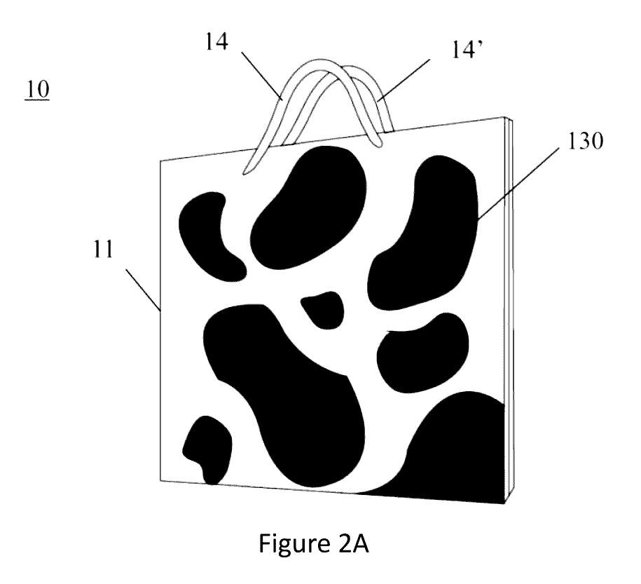

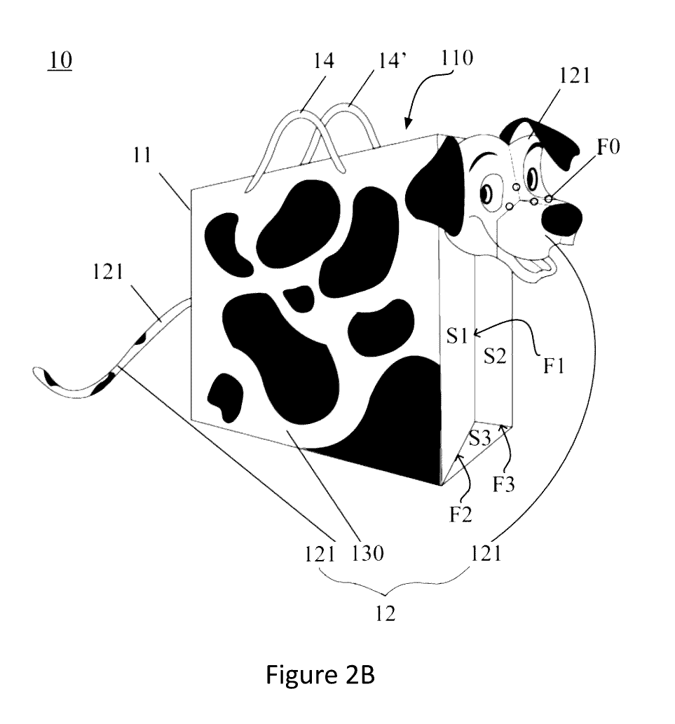

FIG. 2A is a schematic diagram of a foldable statue bag in folding state according to this invention. The foldable statue bag 10 comprises a foldable bag body 11, a pair of handle 14 and 14′, and a pattern 130 on the bag body. FIG. 2A shows the bag is folded and it looks like a normal bag with a drawing on the surface. A recess is formed at each lateral side when the bag is folded.

FIG. 2B is a schematic diagram of the foldable statue bag 10 in unfolded state. The recesses of both lateral sides are flatten and the statue(s) is (are) expanded and protrude(s) to form a 3D structure, such as a dog, in this embodiment.

In the unfolded state, the bag body 11 of the foldable statue bag 10 are expanded, and the statues 121 (in this embodiment is a dog) comprises a dog's head and tail, is expanded in three dimensional decoration. For the convenience of description, the first fold line refers to the fold lines of the bag body and the second fold line means the fold lines of the statue 121.

The statue 121 has at least one second fold line F0 for folding. The second fold line F0 comprises a plurality of sub-fold lines, and the number and location of the fold line can be designed and be integrated with the pattern 130 of the bag body 11 to form a three dimensional (3D) shape integral 12. The pattern 130 can be configured on one surface of the foldable bag body 11 and extended to the statue 121 and shown as an integral 12 when the foldable bag body 11 is unfolded.

The opening 110 is disposed on a top end of the foldable bag body 11. The opening is opened as the unfolded state and closed as the folded state. In the unfold state, the statue 121 is stretched by the second fold lines to expand, such that the statue 121 protrudes from the foldable bag body 11. In the folded state, the statue 121 is folded also and received in the recess of the bag body 11. In some embodiment, the handles 14 and 14′ can be configured to open the bag and convenient to carry for a user.

The first fold lines are on the surface of the bag body 11 for folding to form a foldable bag body 11. Please refer to the FIG. 2B. The bag body 11 can be folded along the fold line F1 and F2, so that the surfaces S1, S2 and S3 are formed. Once the bag 10 is opened, the recess or a protrusion of each of both lateral sides are flattened and the surfaces S1, S2 and S3 co-form a plane. The statue 121 is received or hidden in the recess between two adjacent surfaces in folded state and will be protruded from the recess or the protrusion of the bag to form a 3D structure in unfolded state. In some embodiments, the statue is folded on the protrusion.

In this embodiment, the statue 121, comprising the dog tail and head, is folded to be received and hidden in the recess of the bag body 11 in folded state, and the statue 121 protrudes from the bag body 11 in unfolded state, so that the statue 121 and the pattern 130 can present the overall 3D shape 12 of the dog.

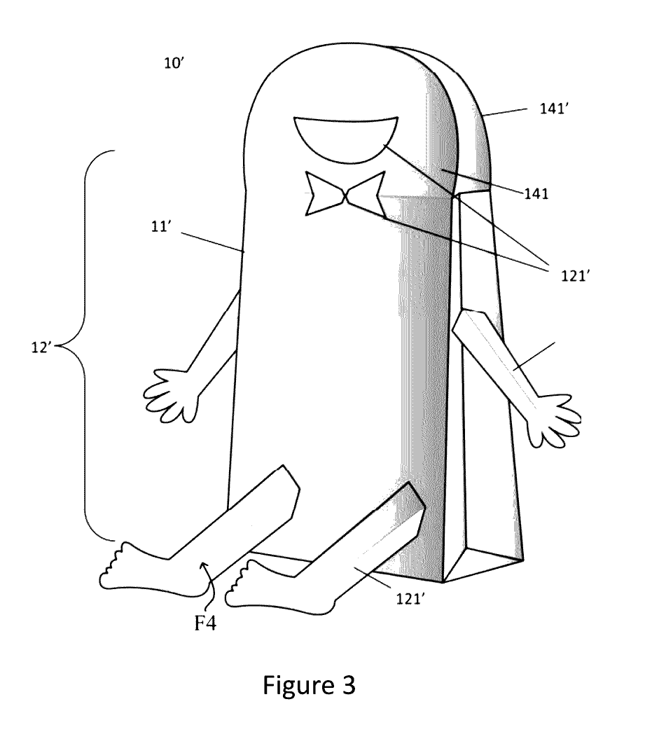

FIG. 3 is a schematic diagram of the foldable statue bag 10′ according to another embodiment of this invention. In some embodiments, the statue 121′ can be configured on a front side, a back side, a left side and/or a right side of the bag body 11′. In some embodiments, part of the statue 121′ is on the front side and/or back side, and another part of the statue 121′ is on the lateral sides of the bag body 11′.

In some embodiments, a pair of handles 141 and 141′ can be configured to be near the top end of the bag body 11′. In some embodiments, the handles 141 and 141′ can be configured to be directly coupled to the front side and back side of the bag body 11′. The handle recess can be configured to be formed between the handles 141 and 141′ as well as the foldable bag body 11′. In some embodiment, the statue 121′ can be configured in the handle recess, and the statue 121′ is received in the handle recess when the handles 141 and 141′ are pulled down, and the statue 121′ expands and protrudes from the bag body 11′ when the handles 141 and 141′ are pulled up. In some embodiments, an indicator light, such as a LED, can be configured to be disposed at least one handle.

In some embodiments, at least one second fold line can be configured on the statue 121′, and the statues 121′ can be transformed from received state to protruded state or from protruded state to received state when the bag body switches between the folded state and the unfolded state. In some embodiments, the second fold line F4 can be configured on the statue and can be received in the front side, back side, or lateral side or any combination of them of the bag body.

The statue 121 in FIGS. 2A and 2B and the statue 121′ in FIG. 3 can be but not limited to structures of animals (such as human, cat, dog, mouse, cow, tiger, rabbit, dragon, snake, horse, goats, sheep, monkey, chicken, pig), plants, teapot, flowerpot, articles of daily use, bicycle or car. The statue bag 10 and 10′ can be a hand bag, or a backpack. In some embodiments, the bag can be configured to be made of paper, water-proof stone paper, plastic, cloth or the combination thereof.

The state 121 in FIGS. 2A and 2B and the statue 121′ in FIG. 3 can be composed by one or more the following three dimensional shape. It is noted the following type of statue is used to explain this convention but not to limit the scope of the invention. The scope of this invention should be understood to comprise any application by using the skill in this document and not being limited in embodiments of this document.

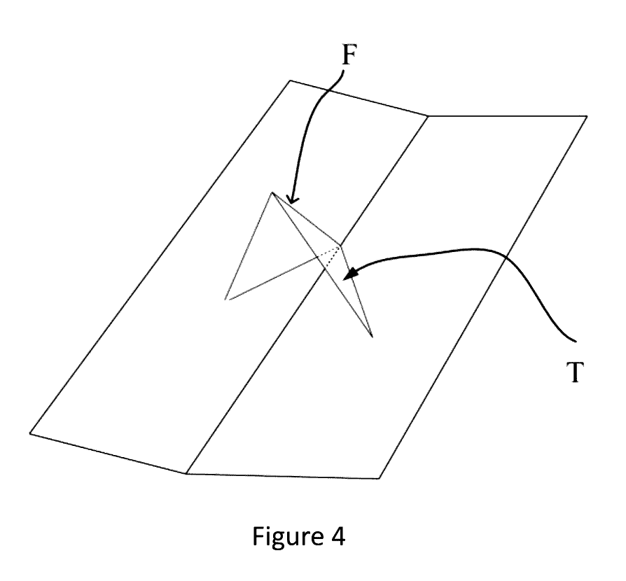

In some embodiments, the statue comprises one or more elementary statues, which is an elementary type of statue, such as a one-piece triangle base T as shown in FIG. 4. In some embodiments, the elementary statue is normally used in limbs of animals to emphasize the main decoration. In some embodiments, the elementary statue can be configured to be a triangle base T and can be folded in v-shaped along the fold line F as shown as FIG. 4. The triangle base T is a triangle shape when folding, and is quadrilateral when unfolding. In some embodiments, the triangle base T can be configured to be a foldable base of a three dimensional structure, and make the statue vary the status.

In some embodiments, the statue comprises one or more fan-shaped statues, which means a statue is shaped to be like a fan. In some embodiments, the fan-shaped statue can be configured to be lifted by an elementary statue, such as the triangle base T. In some embodiments, the statue can be configured to present the wings of birds, angels, bat, hang glider or airplane, and can vary the shape when the bag switches between folded state and the unfolded state. In some embodiments, the statue can be configured to be a fan shape structure and can vary like the fan, such as peacock's tail, lion's mane, flowers, trees, cloaks, skirts, cloths, fireworks, smoke or explosion.

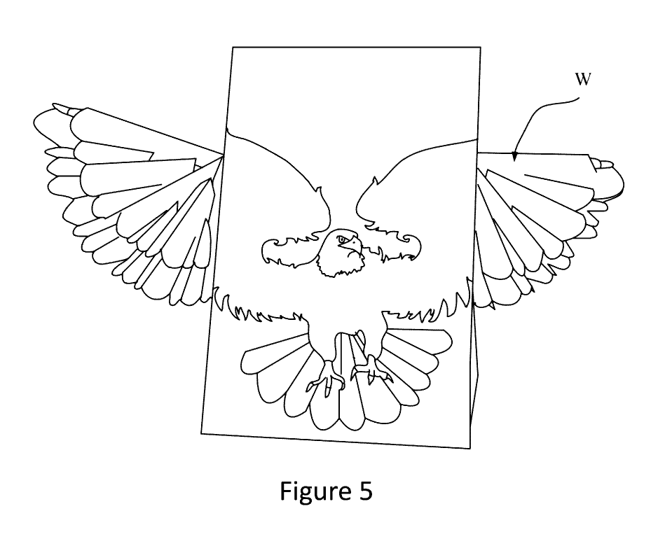

In some embodiments, the statue comprises one or more suspension components, which means the statue is made to like a suspension object. In some embodiments, the suspension statue can be configured to be formed by a suspending flaky component and elementary statue, such as the suspending flaky component can be configured to be at the triangle base T (shown in FIG. 4) to present feather shape such as wings W (shown in FIG. 5). It is noted that sub-fold lines can be configured to make the statue dynamically flutter when the bag body is moved. For example, wings can flutter dynamically when the carrier is walking.

In some embodiments, the statue comprises one or more parallel-stretched statue, which can be configured to be formed as a closed structure or a semi-closed structure. The parallel-stretched statue can be received in the recess or protrusion between two adjacent surfaces along a fold line or can be protruded and hold on the surface of the decoration and/or the bag body, like a statue glued or clamped on the bag body. The parallel-stretched statue can be designed to be like a head of animal, a vehicle, goods, or a flower.

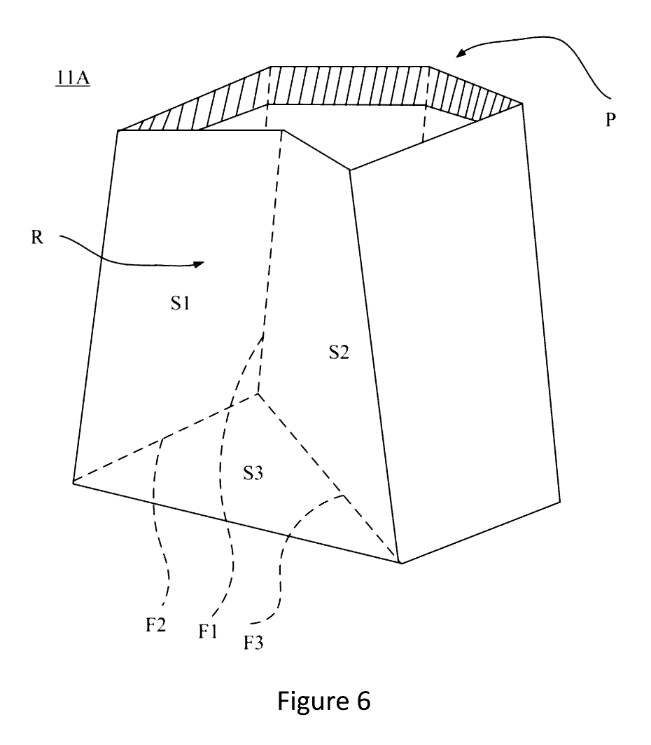

In some embodiments, the statue comprises one or more plane-stretched statues, which means the statue can be configured to be a plane stretched out and be parallel to the surface of the bag body. In some embodiments, the plane-stretched statue can be hold a by an elementary statue, such as the triangle base T. In some embodiments, the plane-stretched statue can be configured to be like a face of animal. In some embodiments, the recess and/or the protrusion for receiving the statue can be configured to be on the front surface of the bag. In some embodiments, as shown as FIG. 6, the surfaces S1, S2 and S3 are divided by the fold lines F1, F2 and F3, and are disposed on the front side of the foldable bag body 11A. The rear side of the foldable bag body can be configured to have corresponding fold lines and surfaces. A recess R is formed on the front side and the corresponding protrusion P can be formed on rear side, or the protrusion is on the front side and the recess is on the rear side. The statue can be configured to be on the recess or the protrusion of the front side of the foldable bag body 11A. It is noted that the statue can protrude from the front side when the bag is unfolded and received when the bad is folded. In some embodiments, the recess R or the protrusion P can be configured at a front side, a back side, a right lateral side, a left lateral side, a top side, or a bottom side of the foldable bag body.

In some embodiments, the statue can be configured to be the integral of the foldable bag body and the sub-statues disposed on the different sides. In some embodiments, the integral of the bag body and the statues can be configured to be an animal, trees, flowers and human and so on. In some embodiments, the integral of the bag body and the statues to express a scene of a story.

In some embodiments, a gasket can be configured to be disposed on the hidden side of the statue along or near the fold line to enhance the strength of the statue. In some embodiments, the strength of the statue can be configured to be different at different part to have different motion to create the effect of fluttering or flickering when the carrier is moving. In some embodiments, the statue can be configured to have waving wings when moving.

In the paper, the inventor propose to use the different type of statue to compose a complex object and the object can be configured to be received in the recess or folded on the protrusion of a foldable bag. The object can be expanded to construct a 3D structure. The folds lines can be configured to be on the bag body and the statue to have an integral design to express an object or a scene of a story. Moreover, the gasket can be configured to be on the hidden side of the statue and then the statue can have different strength in different part to have different motion when the carrier is walking. The different motion can be configured to create the vision effect of fluttering, waving or flickering.

The above embodiments are used to explain the different skill to have different function, effect and feature, but not used to limit the scope of the invention. One or more feature can be used to an application, but any application is not necessary to have all function, effect and features. Any application uses any of the skills disclosed here should be considered to be in the scope of the application.

The following is claimed:

1. A foldable statue bag, comprising:
a foldable bag body with an opening on a top end; and
a statue integrated with the foldable bag body, wherein
the foldable bag body are divided into surfaces by first fold lines,
a recess or a protrusion is formed between two adjacent surfaces by each first fold line, and
the statue has a second fold line for folding so that
the statue is received in the recess or protrude from the protrusion when the foldable bag body is folded, and
the statue is expanded to form a three dimensional decoration when the foldable bag body is unfolded.

2. The foldable statue bag according to claim 1, wherein the foldable statue bag is a paper bag, a plastic bag, or a cloth bag.

3. The foldable statue bag according to claim 1, wherein the statue is disposed on the front side, rear side, bottom side, right lateral side and/or left lateral side of the foldable bag body.

4. The foldable statue bag according to claim 1, further comprising a pair of handles, wherein the handles is near the top end and is connected to the foldable bag body, wherein
a handle recess is formed between the handles and the foldable bag body,
the statue is received in the handle recess when the handles are pulled down, and
the statue is expanded when the handles are pulled up.

5. The foldable statue bag according to claim 4, further comprising an indicator light disposed on at least one of the handles.

6. The foldable statue bag according to claim 5, wherein the indicator light is LED.

7. The foldable statue bag according to claim 1, wherein a pattern is designed on one surface of the foldable bag body and extended to the statue, such that the pattern is shown and form an integral when the foldable bag body is unfolded.

8. The foldable statue bag according to claim 1, wherein the first fold line and/or the second fold line comprises a plurality of sub-fold lines.

9. The foldable statue bag according to claim 8, wherein the sub-fold lines make the statue dynamically flutter when the bag body is moved.

10. The foldable statue bag according to claim 8, wherein the statue is disposed on the bottom side, the right lateral side and/or left lateral side and the sub-fold lines make the statue dynamically flicker when the bag body is moved.
